(19) United States
(12) Patent Application Publication
(10) Pub. No.: US 2025/0277760 A1
(43) Pub. Date: Sep. 4, 2025

(54) SYSTEM AND METHOD OF CABINET RADIOGRAPHY WITH VIDEO MIRRORING

(71) Applicant: KUB Technologies Inc. DBA KUBTEC, Stratford, CT (US)

(72) Inventors: Vikram Butani, Fairfield, CT (US); Chester Lowe, Palm Springs, CA (US)

(73) Assignee: KUB Technologies Inc. DBA KUBTEC, Stratford, CT (US)

(21) Appl. No.: 19/069,396

(22) Filed: Mar. 4, 2025

Related U.S. Application Data
(60) Provisional application No. 63/561,038, filed on Mar. 4, 2024.

(51) Int. Cl. G01N 23/10; G01N 23/04; G01N 23/083

(52) U.S. Cl. CPC G01N 23/10; G01N 23/04; G01N 23/083; G01N 2223/601; G01N 2223/6123; G01N 2223/6126

(57) ABSTRACT

A cabinet x-ray image system for obtaining x-ray images includes a cabinet including a walled enclosure surrounding an interior chamber, a door configured to cover the interior chamber and a sampling chamber for holding a specimen, a main monitor, a separate monitor mirroring the main monitor, an x-ray system including an x-ray source, a detector, and a specimen platform, and a controller configured to selectively energize the x-ray source to emit x-rays through the specimen to the x-ray detector, control the x-ray detector to collect a projection x-ray image of the specimen, determine a density of different areas of the specimen, create a density x-ray image of the specimen, and selectively display the density x-ray image of the specimen on the main monitor and the separate monitor.

### FIELD

The present disclosure relates to the field of a cabinet X-ray incorporating a system and method for the use of video displays, and more specifically to the display of X-ray images of specimen radiographs.

### BACKGROUND

Today, conventional tissue or bone specimen systems can gather a digital specimen radiogram and display it on a system monitor. In these systems, the radiograms of a tissue or bone specimen are only shown on the system main monitor.

Cabinet specimen radiography is considered the most cost-effective screening method for the detection of cancers in surgically removed tissues. However, the limitations of only having 1 monitor displaying the radiograph hinders the clinician and may delay surgical procedures.

### SUMMARY

For purposes of the disclosed embodiments, the terms “physician,” “clinician,” and “medical professional” have the same meaning and are used interchangeably. Furthermore, the terms “X-ray images” and “radiographs” have the same meaning and are used interchangeably. Still further the terms “separate monitor” and “tablet” describe display devices that are capable of operating as a secondary display that mirrors a main or primary monitor, and the terms are used interchangeably. Even when used in the specific context of tissue specimens, bone specimens, and organ specimens, the term “specimen” may be understood to include tissue, organ and bone specimens.

It would be advantageous in surgical excision procedures to allow a medical professional to operate an cabinet X-ray unit to analyze excised specimens by capturing X-ray images or radiographs by the cabinet radiography unit for informational and/or diagnostic purposes. As a result of processing the X-ray images or radiographs, a clinician or physician could view the X-ray images or radiographs in the same and exact orientation on at least one secondary display, for example, one or more separate monitors or tablets for analyzing the excised specimen.

A major advantage of such a system is that the clinician does not have to be standing directly near the system attaining the radiograph but may have a separate monitor close to their theater of operation for viewing the resultant images. Thus, the separate monitor may be proximate to and viewable by a medical professional performing the excision, supervising the excision, or any other medical professional observing the excision or related medical procedures.

With a unit incorporating a system and method of utilizing video monitoring, the clinician can utilize the resultant image to expeditiously visualize the multitude of densities of the specimen excised from the patient to confirm orientation of the excised sample saving time for both the patient on the treatment table and the clinician both on the main system monitor and on multiple separate monitors in multitude locations.

The present disclosure relates to the field of a cabinet X-ray incorporating an X-ray tube and a detector for the production of organic and non-organic specimen images. The computing device receives video data from the detector and determines the orientation and density composition of the specimen based on the captured radiographic data. This facilitates and aids the medical professional in ensuring that the proper amount of tissue has been excised. In particular, the disclosure relates to a system and method with corresponding apparatus for capturing an X-ray image and mirroring the resultant image on a main monitor and a secondary monitor, which may include a separate monitor or a tablet, thus allowing a cabinet X-ray unit to display radiograph images in different locations for easier visualization.

In one embodiment, the aspects of the present disclosure are directed to a system and method including a cabinet X-ray system incorporating a detector. This embodiment includes a cabinet X-ray system, a base unit including an image processor and a display, an imaging chain incorporated into the base unit, including an X-ray source with detector, a system configured to receive photon data and an interface for enabling an analog/digital signal to be transferred from an image capture apparatus to the image processor of the base unit. The system may be further be configured to supply standard or high-definition (HD) real-time images. A camera can be used to receive video data and may be digital to provide electronic images on both a main monitor and the separate monitor. The cabinet X-ray system may concurrently capture an X-ray image and a real-time image. The camera may be mounted onto the system so as to integrate an exact capture/orientation image of the sample being X-rayed. The unit may be enclosed in a cabinet X-ray system. The unit may be utilized for excised tissue, organ or bone specimens. The unit may be utilized for any organic or inorganic specimen that fits inside the system framework or X-ray cabinet. The image capturing mechanism may be mounted in a cabinet X-ray system, such as the cabinet system illustrated in the embodiment shown in FIG. 1.

In this variation of the above-named embodiments, there is a need to display the same images concurrently on multiple displays of a computer system. For example, consider a system with a computing device having an internal display, referred to as a main monitor and an external interface to which an external display, referred to as a separate monitor, is coupled. This system may be used for a presentation (e.g., to an audience in a large room). The clinician or operator of the unit may wish to view the demonstration on the device's main monitor while the audience views the captured radiograph on the separate monitor. The operator may configure the system to operate in this mode and/or select the resolution and/or other parameters for rendering the image content on the main and separate monitors by explicitly specifying multiple display options using multiple user interface mechanisms.

In other situations, there may be a need to display different images on multiple displays of a computer system. For example, a system with a computing device having a main monitor and an external interface to which a separate monitor is coupled may be used by a single user running an application that displays large amounts of information. The user may wish to view the information across both the main and separate monitors (e.g., in an extended desktop mode). The user may configure the system to operate in this mode and/or select the resolution and/or other parameters for rendering different portions of the image content on the main and separate monitors by explicitly specifying multiple display options using multiple user interface mechanisms.

In at least one aspect, the disclosed embodiments are directed to a cabinet x-ray image system for obtaining x-ray images and colorized or grey scale density x-ray images of a specimen including a cabinet defining an interior chamber wherein the cabinet comprises a walled enclosure surrounding the interior chamber, a door configured to cover the interior chamber and a sampling chamber for holding the specimen, a main monitor, a separate monitor mirroring the main monitor, an x-ray system including an x-ray source, a detector, and a specimen platform, and a controller configured to selectively energize the x-ray source to emit x-rays through the specimen to the x-ray detector, control the x-ray detector to collect a projection x-ray image of the specimen when the x-ray source is energized, determine the density of different areas of the specimen from data collected from the x-ray detector of the projection x-ray image of the specimen when the x-ray source is energized, create a density x-ray image of the specimen wherein the different areas of the specimen are indicated as a density or range of densities based on the determined density of different areas of the specimen, and selectively display the density x-ray image of the specimen on the main monitor and the separate monitor.

The specimen platform may be configured for excised tissue, organ or bone specimens.

The specimen platform may be configured for any organic or inorganic specimen that fits inside an x-ray cabinet.

The cabinet x-ray image system may include an optical camera configured to capture an optical image of the specimen, and the controller may be further configured to control the optical camera system to capture and collect the optical image of the specimen, and selectively display the density x-ray image and the optical image of the specimen on the display.

The density x-ray image and the optical image of the specimen may be displayed overlaid.

The x-ray source may emit a first amount of x-rays, the x-ray detector may include a plurality of pixels in an array, each pixel configured to detect a second amount of x-rays received by the pixel, and the controller may be configured to create the density x-ray image from the plurality of pixels by comparing from the first amount of x-rays and the second amount of x-rays for each pixel in the array.

The different areas of the specimen of the density x-ray image may be displayed in different grey scale, different color or different shades of color.

In at least one other aspect, the disclosed embodiments are directed to a method for obtaining x-ray images and colorized or grey scale density x-ray images of a specimen using a cabinet x-ray image system, wherein the cabinet x-ray image system includes a cabinet defining an interior chamber wherein the cabinet comprises a walled enclosure surrounding the interior chamber, a door configured to cover the interior chamber and a sampling chamber for holding the specimen, a main monitor, a separate monitor mirroring the main monitor, an x-ray system including an x-ray source and a photon-counting detector, and a specimen platform, the method including selectively energizing the x-ray source to emit x-rays through the specimen to the x-ray detector, controlling the x-ray detector to collect a projection x-ray image of the specimen when the x-ray source is energized, determining a density of different areas of the specimen from data collected from the x-ray detector of the projection x-ray image of the specimen when the x-ray source is energized, creating a density x-ray image of the specimen wherein the different areas of the specimen are indicated as a density or range of densities based on the determined density of different areas of the specimen, and selectively displaying the density x-ray image of the specimen on the main monitor and the separate monitor.

The cabinet x-ray image system may further include an optical camera configured to capture an optical image of the specimen, and the method may further include controlling the optical camera system to capture and collect the optical image of the specimen and selectively displaying the density x-ray image and the optical image of the specimen on the main monitor and the separate monitor.

The method may further include displaying the density x-ray image and the optical image of the specimen overlaid.

Selectively displaying the density x-ray image of the specimen on the main monitor and the separate monitor may include transmitting the density x-ray image to the separate monitor using a wireless interface comprising one or more of Wi-Fi 802.11, Bluetooth 802.15, or cellular 2G-6G.

Selectively displaying the density x-ray image of the specimen on the main monitor and the separate monitor may include transmitting the density x-ray image to the separate monitor using a protocol comprising Real-time Messaging Protocol (RTMP), Real-time Streaming Protocol (RTSP), Web Real time Communication (WebRTC) or User Datagram Protocol (UDP).

Selectively displaying the density x-ray image of the specimen on the main monitor and the separate monitor may include transmitting the density x-ray image to the separate monitor using a wired or wireless connection.

### BRIEF DESCRIPTION OF THE DRAWINGS

To further clarify the above and other advantages and features of the present disclosure, a more particular description of the disclosure will be rendered by reference to specific embodiments thereof that are illustrated in the appended drawings. It is appreciated that these drawings depict only typical embodiments of the disclosure and are therefore not to be considered limiting of its scope.

The patent or application file contains at least one drawing executed in color. Copies of this patent or patent application publication with color drawings will be provided by the Office upon request and payment of the necessary fee.

The disclosure will be described and explained with additional specificity and detail through the use of the accompanying drawings in which:

FIG. 1 shows an example of an X-ray Cabinet System incorporating aspects of the present disclosure;

FIG. 2 is a block diagram illustrating an exemplary embodiment of a computer system that includes a computing device connected to separate monitor;

FIG. 3 is an exemplary interconnection diagram according to the disclosed embodiments;

FIGS. 4A-4C illustrate gray scale and colorized density x-ray images of a specimen according to the disclosed embodiments; and

FIG. 5A illustrates an x-ray image where a density x-ray image of a specimen in FIG. 5B and an optical image of the specimen in FIG. 5C are displayed overlaid.

### DETAILED DESCRIPTION

This specification includes references to “one embodiment,” “an embodiment,” “one implementation,” or “an implementation.” The appearances of these phrases do not necessarily refer to the same embodiment or implementation. Particular features, structures, or characteristics may be combined in any suitable manner consistent with this disclosure.

Further, various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component.

In general, aspects of this disclosure include a device (cabinet X-ray system) to produce an X-ray image, in grayscale via a standard x-ray detector indicating the density of different areas of the sample or specimen, via photon-counting or density detection via ADU preferably with the resulting 2 images being at substantially or, preferably exactly, the same orientation. The X-ray image can include a two-dimensional (2-D) X-ray image or a synthetic X-ray image assembled from more than one X-ray image (e.g., a tomosynthetic image). The above captured image is then colorized to display the differing densities via ADU or photon counting.

The photo/captured camera optical image, preferably in real-time, may be displayed and mirrored on the main monitor and separate monitor either overlaid/blended/combination image onto the resultant density colorized or gray scale density X-ray image or synthetic X-ray image assembled from more than one X-ray image (e.g., a tomosynthetic image) of the sample or as back to back viewing on a main monitor and separate monitor between at least any two of these images or a side-by-side or Picture-In-a-Picture (PIP) including displayed adjacent to the X-ray image or synthetic X-ray image of the sample. A device capturing both an X-ray image and an optical image, the latter two preferably in real-time, of the specimen facilitates confirmation and orientation for the clinician to verify margins and other specimen features are achieved by the professional after it is removed from a patient.

A preferred embodiment system would be to incorporate an HD (high-definition) optical camera into a cabinet X-ray unit allowing the system to capture an HD optical image and X-ray image either pixelated utilizing a standard x-ray detector or a photon counting detector to display the captured images, in grayscale or colorized of the specimen where the images so obtained can be displayed as disclosed herein.

The present disclosure and embodiments included therein can relate to specimen radiography but the disclosure is not isolated to specimen radiography but may be utilized, for example, for non-destructive testing, pathology as well as any radiographic analysis of organic and non-organic samples or specimens, requiring a cabinet X-ray system but is not limited to just an HD camera but to any camera fitting within the confines of the cabinet X-ray system and include any cabinet x-ray system that can accommodate a main monitor and a separate monitor to display captured images.

Various x-ray detector to obtain radiographs are utilized to capture x-rays. Common types for standard x-ray radiography are charge integrating devices such as Complementary Metal-Oxide-Semiconductor (CMOS), direct or indirect detection flat panels (Scintillator screen, Amorphous Silicon (a-Si), Amorphous Selenium (a-Se), Charge-coupled devices (CCD).

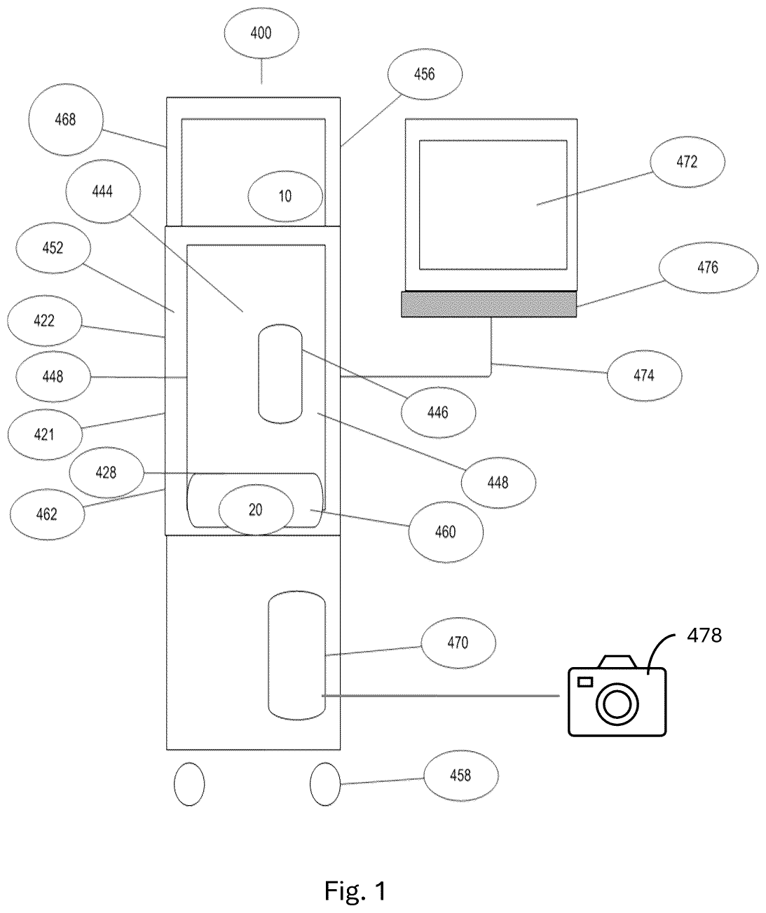

Reference will now be made to the figures wherein like structures will be provided with like reference designations. It is understood that the drawings are diagrammatic and schematic representations of exemplary embodiments of the disclosure and are not limiting of the present disclosure nor are they necessarily drawn to scale. FIGS. 1-3 depict various features and uses of embodiments of the present disclosure, which embodiments are generally directed to a system that can utilize an optical camera, preferably an HD or similar real-time camera, to capture an image of the specimen/sample concurrently with the acquisition of an X-ray image utilizing a standard x-ray detector or a photon-counting x-ray detector.

The systems and methods of embodiments of the present disclosure also address unmet needs by providing 2-D X-ray imaging and tomosynthesis apparatus and techniques that include optical imaging for imaging specimens that overcome the shortfall of the data received from two-dimensional and tomosynthesis imaging systems alone. The aspects of embodiments of the present disclosure also enable the use of tomosynthesis to efficiently provide accurate three-dimensional imaging of a specimen in which overlapping images having differing attenuation characteristics can be obtained by applying a three-dimensional reconstruction algorithm all in an X-ray cabinet system.

As used herein, the term “computer,” “computer system”, or “processor” refers to any suitable device operable to accept input, process the input according to predefined rules, and produce output, including, for example, a server, workstation, personal computer, network computer, wireless telephone, personal digital assistant, one or more microprocessors within these or other devices, or any other suitable processing device with accessible memory.

The term “computer program” or “software” refers to any non-transitory machine-readable instructions, program or library of routines capable of executing on a computer or computer system including computer readable program code.

The terms “camera” or “optical camera” refer to an instrument, including an optical instrument for capturing images in black and white, gray scale or color (preferably color) using reflected and/or emitted wavelengths of the electromagnetic spectrum, for example, visible light or fluorescent light, from an object, similar to a photograph or that which could be viewed by a human eye, using an electronic light-sensitive sensor array. These terms may include such instruments producing images in standard resolution or HD as well as a digital camera that can directly capture and store an image in computer-readable form using an array of electronic light-sensitive elements—typically semiconductor photo-sensors—that produce a light-intensity-dependent electronic signal in response to being illuminated.

Reference will now be made to figures wherein like structures will be provided with like reference designations. It is understood that the drawings are diagrammatic and schematic representations of exemplary embodiments of the disclosure and are not limiting of the present disclosure nor are they necessarily drawn to scale.

Specimen tomography is a three-dimensional specimen imaging system. It involves acquiring images of a sample at multiple viewpoints, typically over an arc or linear path. The three-dimensional image is constructed by the reconstruction of the multiple image data set.

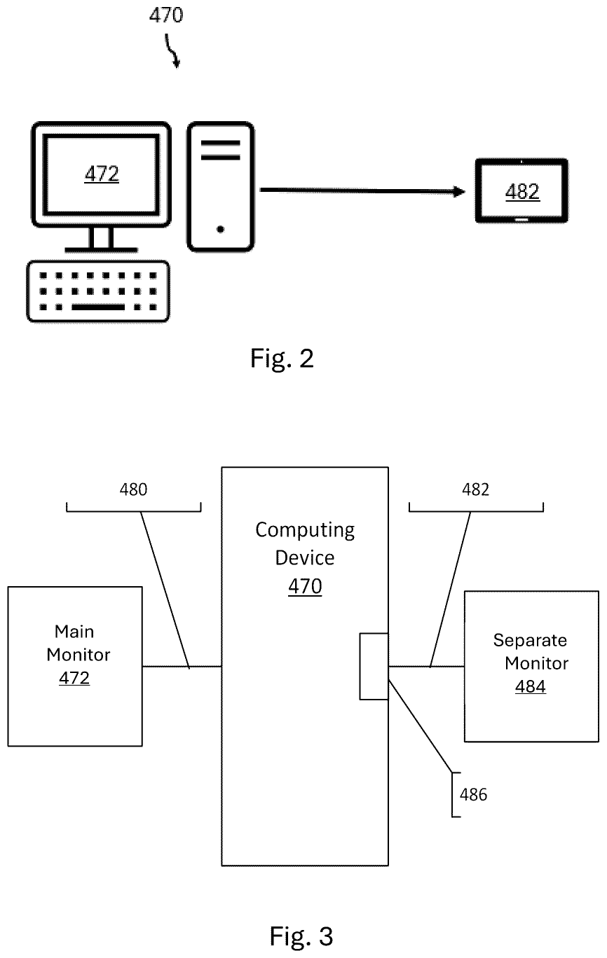

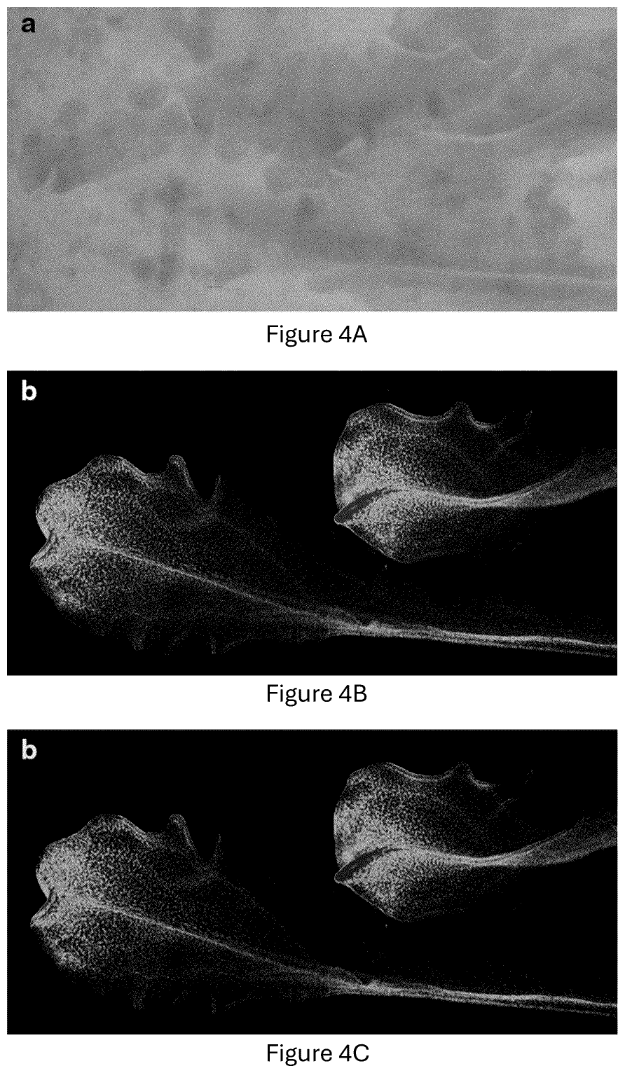

In one embodiment, non-transitory machine readable instructions being executed by one or more processors of the computer 470 is utilized to compile data received from the detector 20 and present resulting images to a suitable display or main monitor 472 and/or a separate monitor 484 (FIGS. 2 and 3) concurrently utilizing a wired or wireless transmitter 486 (FIG. 3) where the x-ray detector 20 generates the respective digital values for the pixels in a two-dimensional array. In some embodiments, the wireless transmitter 486 may be a Bluetooth® transmitter.

FIG. 1 shows one embodiment of an X-ray cabinet system 400 incorporating aspects of the present disclosure. In this embodiment, the X-ray Cabinet System 400 is mounted on wheels 458 to allow easy portability. In alternate embodiments, the X-ray Cabinet System 400 can be mounted on any suitable base or transport mechanism. The cabinet 422 in this example, similar to the exemplary X-ray cabinet 22 of FIG. 1, is constructed of a suitable material such as steel. In one embodiment, the cabinet 422 comprises painted steel defining a walled enclosure with an opening or cabinet chamber 428. Within the cabinet chamber 428, behind door 424, resides an interior space forming a sample chamber 444, which in this example is constructed of stainless steel. Access to the sample chamber 444 is via an opening 446. In one embodiment, the opening 446 of the sample chamber 444 has a suitable door or cover, such as a moveable cover 448. In one embodiment, the moveable cover 448 comprises a door which has a window of leaded glass.

Between the outer wall 421 of cabinet 422 and the sample chamber 444 are sheets of lead 452 that serve as shielding to reduce radiation leakage emitted from the X-ray source 10. In the example of FIG. 1, the X-ray source 10 is located in the upper part 456 of the cabinet 422, in the source enclosure 468. The detector 20 is housed in the detector enclosure 460 at an approximate midpoint 462 of the cabinet 422.

A monitor 472 displays the compiled data and can, for example, be mounted on an articulating arm 474 connected via a hardwire 480 (FIG. 3) that is attached to the cabinet 422. An optical camera 478 may be utilized to capture optical images of specimens. The computer 470 receives commands and other input information entered by the operator via a user interface 476, such as a keyboard and mouse for example. In one embodiment, the computer 470 can comprise a touch screen or near touch screen device. Although the aspects of the disclosed embodiments will generally be described with respect to a computer 470, it will be understood that the computer 470 can comprise any suitable controller or computing device. Such computing devices can include, but are not limited to, laptop computers, minicomputers, tablets and pad devices.

The computer 470 can be configured to communicate with the components of the X-ray cabinet system 400 in any suitable manner, including hardwired and wireless communication. In one embodiment, the computer 470 can be configured to communicate over a network, such as a Local Area Network or the Internet.

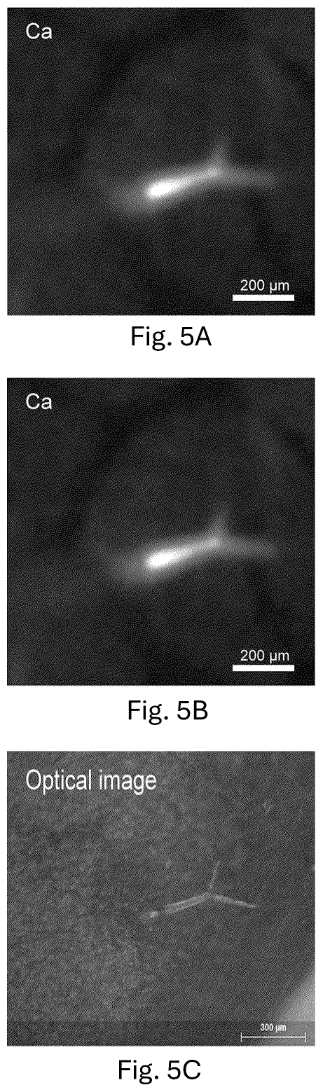

In the systems and methods included in this disclosure as well as the embodiments disclosed herein, the resulting X-ray generated and optical camera images can be displayed each alone, as shown in FIGS. 5B and 5C, or together as overlaid/blended together, as shown in FIG. 5A, adjacent or PIP (Picture-in-Picture) on the monitor 472 (FIG. 1) and separate monitor 484 (FIGS. 2/3) utilizing a wired or wireless signal 482 (FIG. 3) generated by the transmitter 486 (FIG. 3).

Some embodiments of the transmitter 486 may utilize a wireless interface comprising one or more of Wi-Fi 802.11, Bluetooth 802.15, cellular 2G-6G, or any other suitable wireless interface, and a streaming protocol, for example, Real-time Messaging Protocol (RTMP), Real-time Streaming Protocol (RTSP), Web Real time Communication (WebRTC) or User Datagram Protocol (UDP).

This, in turn, provides more flexibility for a clinician and simplifies the procedure. The separate images from the camera and X-ray detector separately as well as the tomosynthetic, overlaid/blended, adjacent and PIP images can be stored in the computer hard drive on the system 470 or a separate memory device, such as for example, a separate hard drive, flash drive, CD-ROM, DVD, etc. for future analysis. The camera can capture a visible light or other electromagnetic wavelength reflected or emitted by the sample or portions thereof, for example, though the use of fluorescent or other markers using a suitable light source where required. Manual input for operation of the cabinet X-ray unit may be initiated via keyboard or monitor touch screen and the resulting image from both the manual-initiated examination can be displayed on the screen and configured in accordance with one example embodiment of the present disclosure.

A radiographic image is composed of a ‘map’ of X-rays that have either passed freely through the specimen or have been variably attenuated (absorbed or scattered) by anatomical structures. The denser the tissue, the more X-rays are attenuated. For example, X-rays are attenuated more by bone than by lung tissue. Contrast within the overall image depends on differences in both the density of structures in the body and the thickness of those structures. The greater the difference in either density or thickness of two adjacent structures leads to greater contrast between those structures within the image.

The detailed images of the embodiments of the present disclosure can be viewed in real-time and/or saved for future examination in various formats in the main computer 470 and then may be transmitted via USB, ethernet, Wi-Fi, etc. in various formats that may include DICOM, .tiff. or .jpeg, non-inclusive.

Display or monitor 472 is for conveniently viewing both images of embodiments of the present disclosure and the output of the processing unit 102 thereon. Display or monitor 472 and separate monitor 484 (FIGS. 2 and 3) may also include a user interface as user interface 476 exemplified in the embodiment of FIG. 1, such as a keyboard and mouse for example. In one embodiment. Display or monitor 472 can comprise a touch screen or near touch screen device separately or integrated as part thereof. Display or monitor 472 and separate monitor 484 may be, for example, LCD screens, CRTs, LCDs, TFTs, plasma displays, LEDs, fluorescent devices, or any type of device adapted to display information. Display or monitor 472 and separate monitor 484 typically show any of the images included in the embodiments of the present disclosure.

Indeed, it is appreciated that the system and its individual components can include additional features and components, though not disclosed herein, while still preserving the principles of the present disclosure. Note also that the base computer can be one of any number devices, including a desktop or laptop computer, etc.

Aspects of the present disclosure may be embodied in other specific forms without departing from its spirit or essential characteristics. The described embodiments are to be considered in all respects only as illustrative, not restrictive. All changes that come within the meaning and range of equivalency of the claims are to be embraced within their scope.

This written description uses examples as part of the disclosure, including the best mode, and also to enable any person skilled in the art to practice the disclosed implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While there have been shown, described and pointed out, fundamental features of the present disclosure as applied to the exemplary embodiments thereof, it will be understood that various omissions and substitutions and changes in the form and details of compositions, devices and methods illustrated, and in their operation, may be made by those skilled in the art without departing from the spirit or scope of the present disclosure. Moreover, it is expressly intended that all combinations of those elements and/or method steps, which perform substantially the same function in substantially the same way to achieve the same results, are within the scope of the present disclosure. Moreover, it should be recognized that structures and/or elements and/or method steps shown and/or described in connection with any disclosed form or embodiment of the present disclosure may be incorporated in any other disclosed or described or suggested form or embodiment as a general matter of design choice. It is the intention, therefore, to be limited only as indicated by the scope of the claims appended hereto.

What is claimed is:

1. A cabinet x-ray image system for obtaining x-ray images and colorized or grey scale density x-ray images of a specimen, the system comprising:
a cabinet defining an interior chamber wherein the cabinet comprises a walled enclosure surrounding the interior chamber, a door configured to cover the interior chamber and a sampling chamber for holding the specimen;
a main monitor;
a separate monitor mirroring the main monitor;
an x-ray system including:
an x-ray source;
a detector; and
a specimen platform; and
a controller configured to:
selectively energize the x-ray source to emit x-rays through the specimen to the x-ray detector;
control the x-ray detector to collect a projection x-ray image of the specimen when the x-ray source is energized;
determine the density of different areas of the specimen from data collected from the x-ray detector of the projection x-ray image of the specimen when the x-ray source is energized;
create a density x-ray image of the specimen wherein the different areas of the specimen are indicated as a density or range of densities based on the determined density of different areas of the specimen; and
selectively display the density x-ray image of the specimen on the main monitor and the separate monitor.

2. The cabinet x-ray image system of claim 1, wherein the specimen platform is configured for excised tissue, organ or bone specimens.

3. The cabinet x-ray image system of claim 1, wherein the specimen platform is configured for any organic or inorganic specimen that fits inside an x-ray cabinet.

4. The cabinet x-ray image system of claim 1, wherein the cabinet x-ray image system further includes:
an optical camera configured to capture an optical image of the specimen; and
the controller is further configured to:
control the optical camera system to capture and collect the optical image of the specimen; and
selectively display the density x-ray image and the optical image of the specimen on the main monitor and the separate monitor.

5. The cabinet x-ray image system of claim 4, wherein the density x-ray image and the optical image of the specimen are displayed overlaid.

6. The cabinet x-ray image system of claim 1, wherein:
the x-ray source emits a first amount of x-rays;
the x-ray detector includes a plurality of pixels in an array, each pixel configured to detect a second amount of x-rays received by the pixel; and
the controller is further configured to:
create the density x-ray image from the plurality of pixels by comparing from the first amount of x-rays and the second amount of x-rays for each pixel in the array.

7. The cabinet x-ray image system of claim 1, wherein the different areas of the specimen of the density x-ray image are displayed in different grey scale, different color or different shades of color.

8. A method for obtaining x-ray images and colorized or grey scale density x-ray images of a specimen using a cabinet x-ray image system, wherein the cabinet x-ray image system comprises:
a cabinet defining an interior chamber wherein the cabinet comprises a walled enclosure surrounding the interior chamber, a door configured to cover the interior chamber and a sampling chamber for holding the specimen;
a main monitor;
a separate monitor mirroring the main monitor;
an x-ray system including:
an x-ray source; and
a photon-counting detector; and
a specimen platform;
wherein the method comprises:
selectively energizing the x-ray source to emit x-rays through the specimen to the x-ray detector;
controlling the x-ray detector to collect a projection x-ray image of the specimen when the x-ray source is energized;
determining a density of different areas of the specimen from data collected from the x-ray detector of the projection x-ray image of the specimen when the x-ray source is energized;
creating a density x-ray image of the specimen wherein the different areas of the specimen are indicated as a density or range of densities based on the determined density of different areas of the specimen; and
selectively displaying the density x-ray image of the specimen on the main monitor and the separate monitor.

9. The method of claim 8, wherein the cabinet x-ray image system further includes:
an optical camera configured to capture an optical image of the specimen;
the method further comprising:
controlling the optical camera system to capture and collect the optical image of the specimen; and
selectively displaying the density x-ray image and the optical image of the specimen on the main monitor and the separate monitor.

10. The method of claim 8, further comprising displaying the density x-ray image and the optical image of the specimen overlaid.

11. The method of claim 8, wherein selectively displaying the density x-ray image of the specimen on the main monitor and the separate monitor comprises transmitting the density x-ray image to the separate monitor using a wireless interface comprising one or more of Wi-Fi 802.11, Bluetooth 802.15, or cellular 2G-6G.

12. The method of claim 8, wherein selectively displaying the density x-ray image of the specimen on the main monitor and the separate monitor comprises transmitting the density x-ray image to the separate monitor using a protocol comprising Real-time Messaging Protocol (RTMP), Real-time Streaming Protocol (RTSP), Web Real time Communication (WebRTC) or User Datagram Protocol (UDP).

13. The method of claim 8, wherein selectively displaying the density x-ray image of the specimen on the main monitor and the separate monitor comprises transmitting the density x-ray image to the separate monitor using a wired or wireless connection.
